(19) United States
(12) Patent Application Publication
(10) Pub. No.: US 2003/0026301 A1
(43) Pub. Date: Feb. 6, 2003

(54) Method and device for locking the wavelength of an optical signal

(76) Inventors: Aurelio Pianciola, Casteggio (IT); Paolo Milanese, Olevano Di Lomellina (IT)

Correspondence Address: Corning Incorporated, SP TI 03, Corning, NY, 14831, US

(21) Appl. No.: 10/168,062

(22) PCT Filed: Dec. 14, 2000
(86) PCT No.: PCT/EP00/12857

(30) Foreign Application Priority Data
Dec. 17, 1999 (EP) 99125209.9
Dec. 23, 1999 (US) 60171611

(51) Int. Cl. H01S 3/098

(52) U.S. Cl. 372/18

(57) ABSTRACT

Device for locking the wavelength of an optical signal emitted by a source, comprising: a coupler (2) capable of extracting a fraction of the said optical signal, a splitter (4) capable of dividing the said fraction of the said optical signal into a first sub-fraction and a second sub-fraction, a first filter (FP1) capable of filtering the said first sub-fraction and of generating an optical signal when its wavelength is displaced to values below the wavelength of the optical signal to be locked, a second filter (FP2) capable of filtering the said second sub-fraction and of generating an optical signal when its wavelength is displaced to values above the wavelength of the optical signal to be locked, an opto-electronic device (6) capable of converting the said first filtered sub-fraction of the optical signal and the said second filtered sub-fraction of the optical signal, and of generating a signal corresponding to the said size of the displacement and a signal identifying the direction of the said displacement, both of which are to be used to adjust the emission spectrum of the said source.

The present invention relates to a method and device for locking the wavelength of an optical signal.

Preferably, the present invention relates to a device used for locking an optical signal emitted by an optical source.

An example of application of this device is the locking of each individual component of a multiple-wavelength signal emitted by a laser, for example a semiconductor laser, within a transmitter in a wavelength division multiplexing, or WDM, optical telecommunications system.

For wavelength division multiplexing, or WDM, transmission, a plurality of transmission signals which are independent of each other have to be sent along the same line, consisting of optical fibres, by means of multiplexing in the optical wavelength domain; the transmitted signals can be either digital or analogue, and they are distinguished from each other because each of them has a specific wavelength separate from those of the other signals.

To implement this WDM transmission, specific wavebands of specified width, referred to below as channels, have to be assigned to each of the signals at different wavelengths.

These signals, identified below by a wavelength value, called the central wavelength of the signal, have a certain spectral width around the central wavelength value, which depends, in particular, on the characteristics of the signal source laser and on the modulation imparted to it to associate a data element with the signal.

U.S. Pat. No. 5,798,859 describes a method and device for locking the wavelength of an optical signal, comprising an element having a wavelength-dependent characteristic, such as a Fabry-Perot filter, used to generate a signal whose intensity varies with the wavelength of the said optical signal. This signal is compared with a reference signal in such a way as to generate a signal which gives an indication of the variation of the wavelength of the optical signal and which can be used for controlling and locking the wavelength.

U.S. Pat. No. 5,777,763 describes a device for measuring and controlling the wavelength of an optical signal, including an input lens which receives the optical signal from an input fibre, a multiple Bragg grating and an output lens. The multiple Bragg grating reflects in a differentiated way parts of the input signal having different predetermined characteristics, and sends them to a set of sensors, while the remaining portion of the input signal is transmitted to the output lens which focuses the signal on an output fibre. The aforesaid different predetermined characteristics can be the different wavelengths of the optical signal, and it is therefore possible to monitor the different wavelengths of the optical signal by means of the sensors. This device can be connected in series with a multiple-wavelength telecommunications line.

A wavelength locking device is produced and marketed by Uniphase Telecom Products under the name HRWL 0801.

The “Application Note” report under the title “Wavelength monitoring and control”, published in January 1998 by Uniphase, describes a wavelength locking device which comprises a coupler which extracts a portion of the power of the optical signal to be locked. This signal portion is sent to an optical splitter, which splits the signal portion into two branches. In each of the said branches there is an interference filter and a photodiode down-line from the filter. The outputs of the two photodiodes are sent to a differential amplifier, which amplifies the difference of the two signals from the photodiodes. The interference filters have a transfer function in which the central wavelength is slightly shifted, by a predetermined quantity, with respect to the wavelength of the signal to be locked. In particular, this quantity is negative in one filter and positive in the other filter. Thus the quantity of signal transmitted from the filter to the photodiode is equal in the two branches, if the wavelength of the signal to be locked does not vary. In this case, the differential amplifier does not amplify any signal. If there is an undesired displacement of the wavelength to be locked, the signals emitted by the photodiodes become different from each other, and the differential amplifier will amplify a signal proportional to this displacement, which can be used to lock the source from which the analysed optical signal has been emitted.

U.S. Pat. No. 5,875,273 describes a system for controlling the emission wavelength of a direct modulation laser, in which a Bragg grating is coupled to the output of the said laser. The emission of the laser has a wide spectrum, but has a light emission peak at a given wavelength. One portion of the spectrum of the grating is essentially vertical at a particular wavelength. The amounts of light transmitted and reflected by the said grating are compared to generate a control signal for the laser, in such a way as to lock its emission at the wavelength of its maximum light emission.

The applicant has observed that the efficiency of this device depends directly on the precision in terms of wavelength of the interference filters.

The article “Wide band Fabry-Perot-like filters in optical fibers”, published in the journal IEEE Photonics Technology Letters, Vol. 7, No. 1, January 1995, pages 78-80, describes a wide band Fabry-Perot filter consisting of a pair of in-fibre gratings arranged in series with each other. The two gratings are identical and are placed at a distance from each other defined as δ×, which represents the wavelength of the Fabry-Perot cavity. A filter of this type has a spectral response which depends on the wavelength of δ× and on the pitch of the two in-fibre gratings.

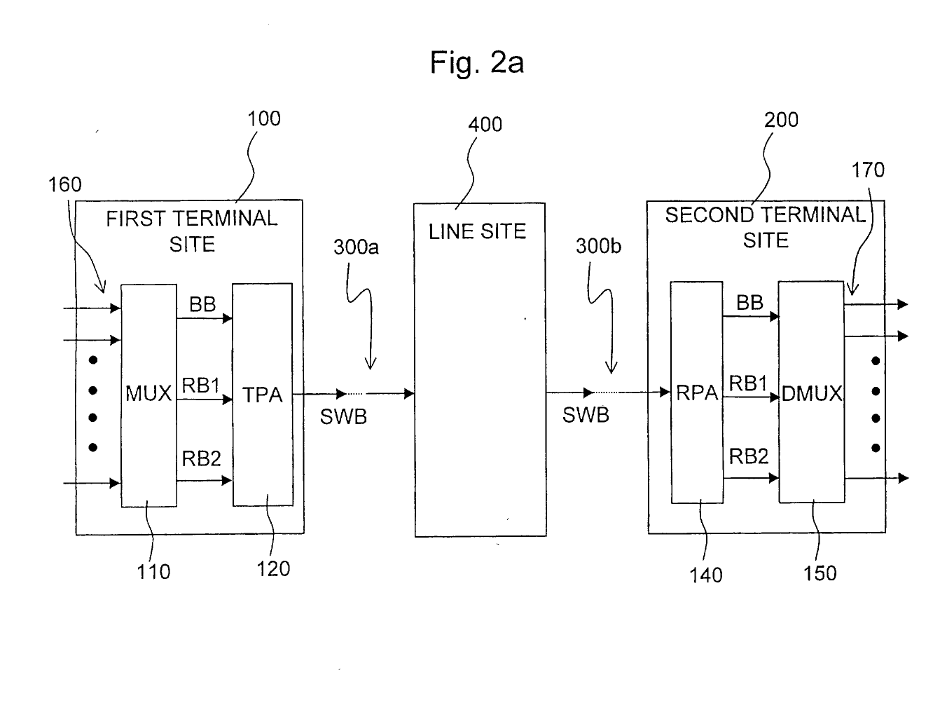

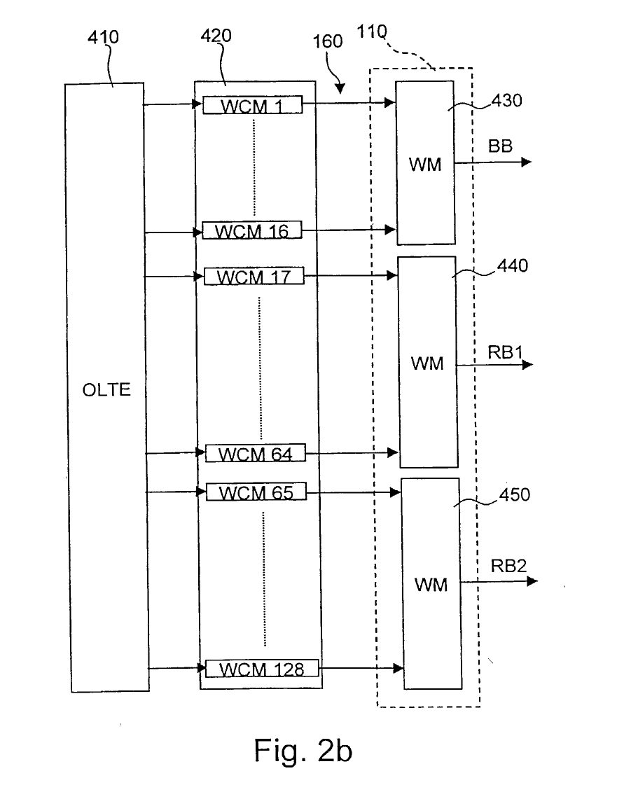

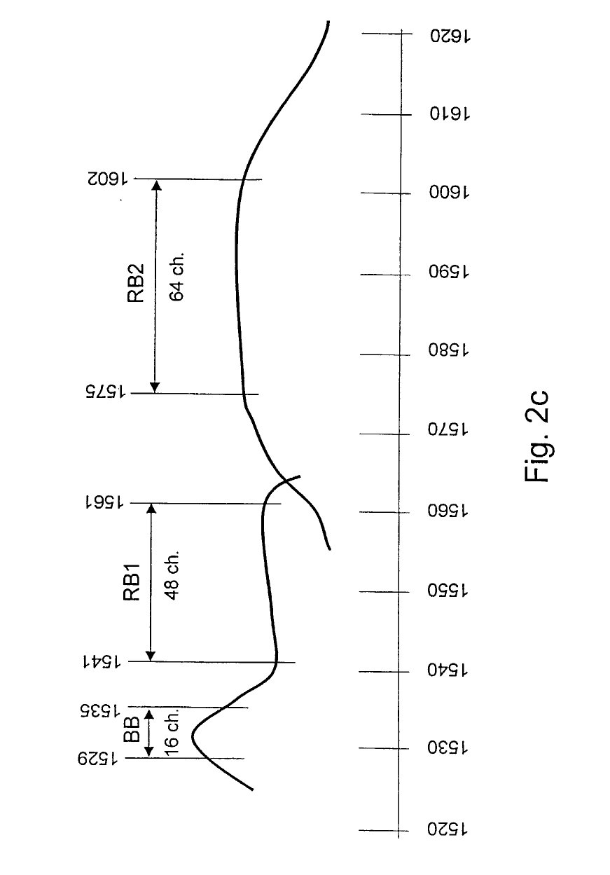

In particular, the filter has a periodic spectral response, shown in FIG. 2 of the aforesaid article, the period of which depends on the cavity length δ×. The period is measured between two consecutive peaks of maximum transmissivity and is termed the FSR (Free Spectral Range). The wavelengths at which maximum transmissivity is found depend on the pitch of the gratings and on the FSR. Different spectral responses of the filter for different cavity lengths δ× are demonstrated in the article.

The applicant has observed that when the cavity length increases the FSR decreases, and the leading and trailing edges of the transmissivity peak become steeper. The FSR and the steepness of the transmissivity peak are therefore inversely proportional.

The principal parameters defining a wavelength locking device (“wavelength locker”) are:

capture range (CR): typical values, ±50 GHz;

wavelength accuracy (WA): typical values, ±2-2.5 GHz;

wavelength stability (WS): typical values, ±1.5-2.5 GHz.

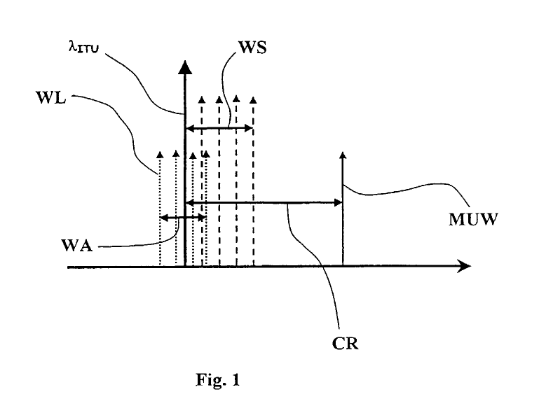

FIG. 1 shows a graph which illustrates these parameters, starting from a wavelength to be locked (WL).

For the purposes of the present invention, the aforesaid parameters are defined as follows:

FSR (free spectral range): the range of wavelengths between two transmissivity peaks of a filter;

wavelength locked (WL) : the nominal wavelength at which the wavelength of the optical signal to be locked is to be fixed;

capture range (CR): the range of wavelengths between the wavelength locked and the maximum unlocked wavelength (MUW);

wavelength accuracy (WA): the range of wavelengths centred on the wavelength locked WL within which the signal is considered to be locked;

wavelength stability (WS): the range of wavelengths centred on the wavelength locked WL, within which the wavelength locked WL can vary as a result of environmental variations and/or the ageing of the components.

The applicant has observed that the performance of an optical signal wavelength locking device depends on the configuration and type of the filter used; for example, the wavelength stability WS is affected by the thermal stability of the wavelength transfer function of the filters, in other words the variability of the said transfer function with temperature. Moreover, the requirements for wavelength accuracy WA and capture range CR conflict with each other, since, in order to have a wide operating range, the spectral response of the filters must not be very narrow, but this implies a low dynamic characteristic and consequently a lower wavelength accuracy. This is because the wavelength accuracy depends on the steepness of the spectral response of the filters, and this steepness is in conflict with the requirement for the filter to have a wide spectral response.

The capture range CR which is to be guaranteed is a design parameter of the filter, since, if the response is periodic (Fabry-Perot etalon) it limits the minimum free spectral range of the structure (in other words the distance between two transmission peaks in the transmission function).

In a multiple-wavelength optical telecommunications system of the DWDM (dense wavelength division multiplexing) type, the wavelength grid used in the transmitted channels is preferably 25-50 GHz, for a transmission speed of 10-40 Gbit/s (grid according to ITU-T recommendations).

A multiple wavelength system is defined as dense (DWDM) when the channel spacing is less than 100 GHz.

The distance in wavelengths between two adjacent channels is very small, and therefore a locking device with a high accuracy WA is required in order to lock each of the wavelengths in such system. Moreover, the whole waveband is very wide, and the device must be capable of locking each of the channels making up the whole transmission band, and therefore the capture range CR must be very wide.

The applicant has developed a device for optical signal wavelength locking which has a sufficiently wide capture range, combined with a high accuracy, making it possible to lock each channel of a dense multiple wavelength system, in other words one with a channel spacing of less than 100 GHz.

Additionally, the locking device according to the present invention preferably extracts the signal to be locked before it is modulated.

In a first aspect, the present invention relates to a method for locking the wavelength of an optical signal emitted by a source, having the following stages:

extracting a fraction of the said optical signal emitted by the said source;

filtering the said fraction of the said optical signal in such a way as to generate a first optical signal when its wavelength is displaced towards values below the nominal wavelength, a second optical signal when its wavelength is displaced towards values above the nominal wavelength,

converting the said first optical signal and the said second optical signal into an electrical signal,

generating a signal corresponding to the size of the said displacement and a signal identifying the direction of the said displacement, both of which are to be used for adjusting the emission spectrum of the said source.

In particular, the said stage of filtering the said fraction of the said optical signal comprises:

dividing the said fraction of the said optical signal into a first sub-fraction and a second sub-fraction,

filtering the said first sub-fraction in such a way as to generate a first optical signal when its wavelength is displaced towards values below the nominal wavelength,

filtering the said second sub-fraction in such a way as to generate a second optical signal when its wavelength is displaced towards values above the nominal wavelength.

In particular, the said stage of generating a signal proportional to the size of the said displacement comprises counting the pulses of the said electrical signal.

In a further aspect, the present invention relates to a device for locking the wavelength of an optical signal emitted by a source, comprising:

a coupler capable of extracting a fraction of the said optical signal,

a splitter capable of dividing the said fraction of the said optical signal into a first sub-fraction and a second sub-fraction,

characterized in that it comprises:

a first filter capable of filtering the said first sub-fraction and of generating an optical signal when its wavelength is displaced to values below the wavelength of the optical signal to be locked,

a second filter capable of filtering the said second sub-fraction and of generating an optical signal when its wavelength is displaced to values above the wavelength of the optical signal to be locked,

an opto-electronic device capable of converting the said first filtered sub-fraction of the optical signal and the said second filtered sub-fraction of the optical signal, and of generating a signal corresponding to the said size of the displacement and a signal identifying the direction of the said displacement, both of which are to be used to adjust the emission spectrum of the said source.

In particular, the said opto-electronic device comprises:

a pair of photodiodes,

a threshold comparator device, comprising a differential amplifier, to whose inputs the signal emitted by the said pair of photodiodes is applied,

an adder, comprising a differential amplifier to whose inputs the signal emitted by the said pair of photodiodes is applied,

a counter which receives the signal from the output of the said adder,

a digital-analogue converter which receives the signal from the output of the said adder.

In a further aspect, the present invention relates to a device for filtering an optical signal, comprising a first grating having a first chirping factor and a second grating having a second chirping factor, characterized in that

the said first grating and the said second grating are arranged in series with a predetermined distance between them, to form a Fabry-Perot cavity having a length equal to the said predetermined distance.

Preferably, the said first chirping factor is different from the said second chirping factor.

Preferably, the said first grating and second grating are formed in an optical fibre.

Alternatively, the said first grating and second grating are formed in an optical waveguide.

Further characteristics and advantages of the present invention are stated in greater detail in the following description, with reference to the attached drawings which are provided solely for the purpose of explanation and without any restrictive intent, and which show:

in FIG. 1, a graph which illustrates the parameters for an optical signal wavelength locking device, starting from a wavelength to be locked, WL;

in FIG. 2a, a diagram of a multiple-wavelength telecommunications system;

in FIG. 2b, a diagram of a transmission station for a multiple-wavelength telecommunications system;

in FIG. 2c, a graph of the spectral emission of an optical amplification station in the waveband from 1525 nm to 1620 nm;

in FIG. 3, a diagram of an optical signal wavelength locking device according to the present invention;

in FIG. 4, a diagram of the device of FIG. 3, showing in particular the block diagram of the opto-electronic device 6;

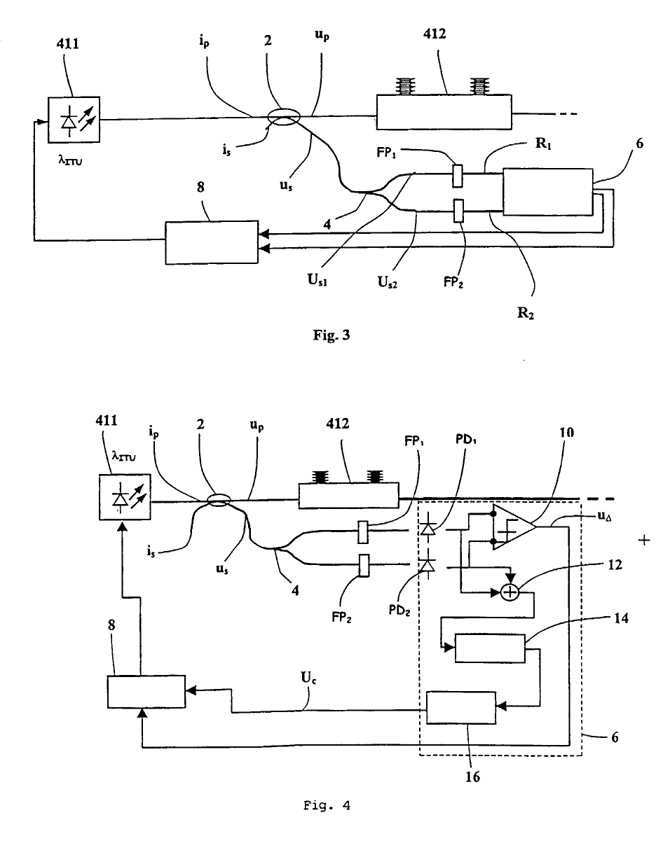

in FIG. 5, the graph of the transfer function of two high-selectivity filters according to the present invention, used in the locking device of FIG. 3;

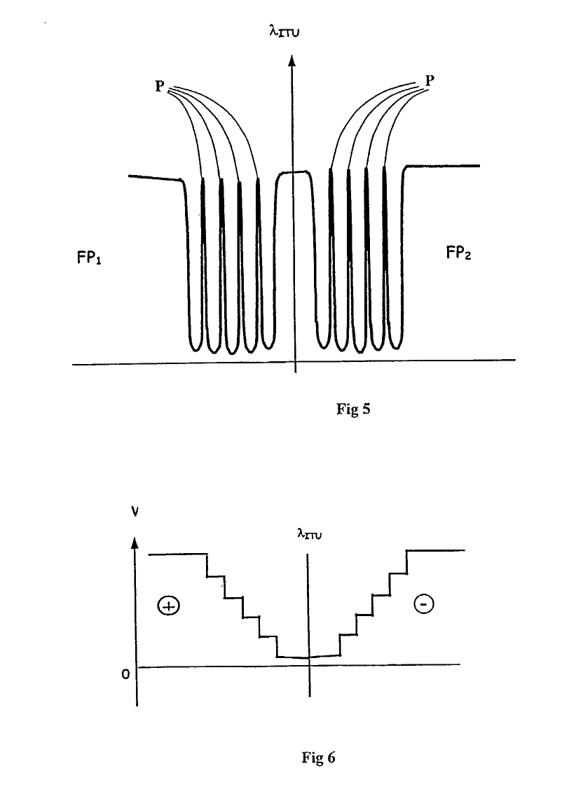

in FIG. 6, the graph of an analogue signal plotted at the output of the digital-analogue converter included in the locking device of FIG. 3;

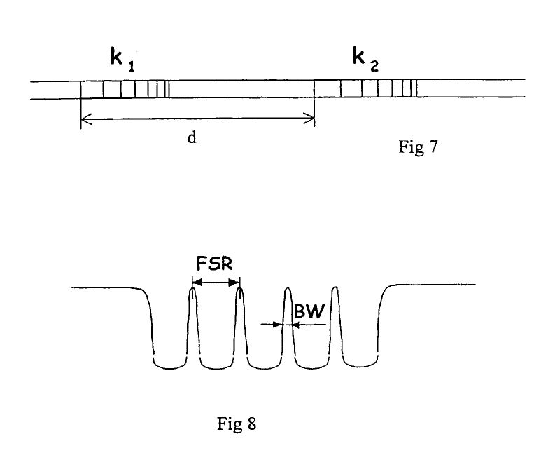

in FIG. 7, a high-selectivity filter formed in an optical fibre according to the present invention;

in FIG. 8, the graph of the transfer function of the filter of FIG. 7.

With reference to FIG. 2a, an optical transmission system includes a first terminal site 100, a second terminal site 200, an optical fibre line 300a, 300b which connects the two terminal sites and at least one line site 400 interposed in the course of the said optical fibre line.

For the sake of simplicity, the transmission system described is unidirectional—in other words, the optical signal travels from one terminal site to the other—but the following considerations are also valid for bidirectional systems, in which the optical signal travels in both directions.

In this example, the system is suitable for transmission in a maximum of 128 channels, but the maximum number of channels may be different, according to the configurations which the system can assume.

The first terminal site 100 preferably comprises a multiplexing section 110 (MUX) for a plurality of input channels 160 and a power amplification section 120 (TPA).

The second terminal site preferably comprises a preamplification section 140 (RPA) and a demultiplexing section 150 (DMUX) for a plurality of output channels 170.

Each input channel 160 is received by the multiplexing section 110, described in detail in FIG. 2b below, which preferably groups the channels in three sub-bands, denoted successively as BB (blue band) , RB1 (red band 1) and RB2 (red band 2). It is equally possible for the optical transmission system to carry out division into a number of sub-bands which is larger or smaller than the three described. The three sub-bands are sent to the power amplification section 120 and then to the line 300.

The power amplification section 120 preferably receives the three sub-bands, separated from each other by the multiplexing section, amplifies them separately, and then combines them to produce a wide band (SWB) WDM signal to be sent to the transmission line 300.

The line site 400 receives the wide band WDM signal, re-divides it into the three sub-bands BB, RB1 and RB2, amplifies the signals of the three sub-bands separately, adds some channels to, or removes some channels from, these three sub-bands if necessary, and recombines the three sub-bands to reconstruct the wide band WDM signal.

Further line sites 400 can be distributed along the line 300 in suitable positions, according to the section of line travelled up to the point in question, whenever it is necessary to amplify the WDM optical signal, or more generally to modify its characteristics.

The second terminal site 200 receives the wide band signal and amplifies it within the preamplification section 140, which preferably divides the WDM signal again into the three sub-bands BB, RB1 and RB2. The demultiplexing section 150 receives the three sub-bands and divides them into single-wavelength signals 170.

The number of input channels 160 may be different from the number of output channels 170, since some channels may be added or removed at the line sites 400.

FIG. 2c shows a spectral emission graph of the amplifiers, illustrating the three sub-bands of the example described below. In particular, the first sub-band BB preferably contains signals having wavelengths in the range from 1529 nm to 1535 nm, the second sub-band RB1 preferably contains signals having wavelengths in the range from 1541 nm to 1561 nm, and the third sub-band preferably contains signals having wavelengths in the range from 1575 nm to 1602 nm.

16 channels are preferably allocated to the first sub-band, 48 channels are preferably allocated to the second sub-band, and 64 channels are preferably allocated to the third sub-band.

Advantageously, the adjacent channels in a system with a total of 128 channels have a frequency spacing of 50 GHz.

FIG. 2b shows in greater detail the input section of the first terminal site 100. This site comprises, in addition to the multiplexing section 110 and the amplification section 120, a line terminal section 410 (OLTE) and a wavelength conversion section 420 (WCM).

The line terminal section 410 corresponds to a terminal apparatus, for example one according to one of the SONET, ATM, IP or SDH standards, and includes a number of transceivers corresponding to the number of channels which are to be transmitted along the line. In the example described, the OLTE has 128 transceivers. The OLTE transmits a plurality of channels, each at one of its wavelengths.

These wavelengths can be modified, to make them compatible with the telecommunications system, by wavelength converters WCM1-WCM128 which form part of the WCM section 420. The converters WCM1-WCM128 are capable of receiving a signal at a generic wavelength and of converting it to a signal at a predetermined wavelength as described, for example, in U.S. Pat. No. 5,267,073 in the name of the present applicant.

Each wavelength converter WCM preferably comprises a photodiode which converts the optical signal to an electrical signal, a laser source, and an electro-optical modulator, of the Mach-Zehnder type for example, to modulate the optical signal generated by the laser source at the predetermined wavelength, with the electrical signal converted by the photodiode.

Alternatively, this converter may comprise a photodiode and a laser diode modulated directly by the electrical signal of the photodiode in such a way as to convert the optical signal to the predetermined wavelength.

Devices such as amplifiers, re-timers and/or signal squarers can be connected between the photodiode and the modulator and/or between the photodiode and the direct modulation laser. It is also possible to connect a transmission FEC (forward error correction) module, which adds data to the time frame of the signal to enable the receiver to correct errors which occur along the line, thus improving the BER.

In a further alternative, this converter includes a receiver (for example, one according to one of the standards indicated above) for receiving an optical signal and converting it into a corresponding electrical signal, together with a laser source and an electro-optical modulator for modulating the optical signal generated by the laser source at the predetermined wavelength, using the electrical signal from the receiver.

Wavelength converters of the type indicated are marketed by the applicant under the symbols WCM, RXT and LEM.

In all cases, the wavelength converters or the optical signal generators present at the first terminal site 100 generate corresponding working optical signals having wavelengths within corresponding channels lying within the working bandwidth of the amplifiers arranged sequentially in the system.

The multiplexing section 110 preferably comprises three multiplexers 430, 440 and 450. Preferably, for a system with 128 channels, the first multiplexer 430 combines the signals from the first 16 converters WCM 1-16 to form the first sub-band BB, the second multiplexer 440 combines the signals from the converters WCM 17-64 to form the second sub-band RB1, and the third multiplexer 450 combines the signals from the converters WCM 65-128 to form the third sub-band RB2.

The multiplexers 430, 440 and 450 are passive optical devices, by means of which the optical signals transmitted in corresponding optical fibres are superimposed in a single fibre; examples of devices of this kind are fused fibre couplers or planar optic couplers, Mach-Zehnder devices, AWGs, polarization filters, interference filters, micro-optic filters, or similar.

By way of example, a suitable combiner is the 8 WM or 24 WM combiner marketed by the present applicant.

The amplification section 120 is capable of amplifying the signals of the sub-bands in such a way as to raise their level to a value sufficient to pass through the successive section of optical fibre present before new means of amplification, maintaining at the end a sufficient power level to provide the requisite transmission quality. After the said power amplifier, the signals of the bands are then combined with each other, by means of a band-pass combining filter, so that they can be injected into a first section 300 of optical line, usually consisting of a single-mode optical fibre inserted in a suitable optical cable, with a length of several tens (or hundreds) of kilometres, for example approximately 100 kilometres.

The optical fibres used for connections of the type described can be optical fibres of the dispersion shifted type.

However, the type of fibre with a step index profile is preferable in cases in which it is desirable to eliminate or reduce the non-linear effects of intermodulation between adjoining channels, which may be particularly significant in dispersion shifted fibres, particularly if the space between the channels is very small.

Step index fibres have a dispersion of approximately 17 ps/mm km at a wavelength of approximately 1550 nm. Lower values of dispersion, which are still sufficient to make the aforesaid intermodulation phenomena negligible, for example from 1.5 to 6 ps/km, can be obtained with the fibres called NZD (non-zero dispersion), which are described, for example, in ITU-T Recommendation G.655.

At the end of the said first section of optical line 300a, there is a first line site 400, capable of receiving multiple-wavelength signals (or WDM signals) which have been attenuated during their travel through the fibre, and of amplifying them to a level sufficient for feeding them to a second section of optical fibre 300b, having characteristics similar to those of the preceding one.

Subsequent line amplifiers and corresponding sections of optical fibre, also usually inserted in corresponding cables, cover the total required transmission distance until the second terminal station is reached.

For the demultiplexing section 150, use may be made of a component of the same type as that used in the multiplexing section 110, as described above, this component being installed in the opposite configuration, in combination with corresponding pass-band filters placed on the output fibres.

Examples of pass-band filters of the type indicated are those marketed by Micron-Optics.

Alternatively, a demultiplexing section 150 suitable for the purpose comprises, for example, an AWG (array waveguide grating) called 24 WD or 8 WD.

The described configuration is particularly suitable for transmission over distances of the order of approximately 500 km, with a high transmission speed, for example 10 Gbit/s per channel or above.

In the described system, the line amplifiers, conveniently produced in a multiple-stage configuration, are designed for operation with a total output optical power of approximately 22 dBm.

Additionally, the power amplifier 120 may advantageously have the same configuration as the line amplifiers.

The transmission system configuration described above has been found to be particularly suitable for providing the desired performance, particularly for transmission in a plurality of wavelength division multiplexing channels, given a particular selection of the properties of the line amplifiers which form part of it, particularly in respect of the capacity of transmitting the selected wavelengths without any of them being penalized with respect to the others.

In particular, uniform behaviour for all the channels can be ensured, in the waveband from 1529 to 1602 nm or 1529-1535 nm or 1542-1561 nm or 1575-1602 nm in the presence of amplifiers suitable for operation in cascade, by making use of line amplifiers designed to have an essentially uniform (or “flat”) response at the various wavelengths when operating in cascade.

The configuration of the amplifier varies according to the waveband which it is to amplify. Wavebands such as those defined above are amplified by amplifiers of different types, described below.

A device for locking the wavelength of an optical signal can advantageously be inserted in a multiple-wavelength telecommunications system of the type described above, being placed within the WCM converters of the wavelength conversion section 420.

FIG. 3 shows, by way of example, a diagram of the wavelength locking device placed after the said converters; of this device, a laser 411, which emits an optical signal at one of the wavelengths of the transmission channels, and a modulator 412, which adds the data to the said signal emitted by the laser, are shown. This laser and modulator are, for example, those located within each converter WCM.

In particular, this device comprises a coupler 2 located between the laser 411 and the modulator 412, which extracts a fraction of the optical signal to be locked, before the data from the modulator is added to it.

In particular, this coupler preferably has a first input iₚ on a polarization-maintaining fibre and a second input i₅ on a single-mode fibre, a first output uₚ consisting of a polarization-maintaining fibre and a second output uₛ consisting of a single-mode fibre.

The coupler may be, for example, a fusion coupler or a coupler made by micro-optic technology.

An optical signal polarized along an axis of birefringence of a polarization-maintaining fibre, and injected into the input iₚ of the said fibre, exits partially from the first output uₚ, keeping the polarization of the optical signal unchanged, and partially from the second output uₛ with a fraction of the optical power of the polarized optical signal sent to iₚ according to a coupling ratio defined at the time of construction of the coupler. The fraction of the optical signal to be locked-is taken from the output uₛ of the single-mode fibre iₛ.

This coupler 2 is a coupler between a polarization-maintaining fibre and a single-mode fibre, since the optical fibre from which it is desired to extract a principal fraction of the signal to be locked is a polarization maintaining fibre.

The device also comprises an optical power splitter 4 into whose input i_{d} the said fraction of the optical signal to be locked is injected, and which divides this signal fraction between the two outputs uₛ₁ and uₛ₂ into a first sub-fraction and a second sub-fraction, according to a splitting ratio which is preferably 50%.

The optical splitter 4 is an optical splitter formed preferably from fused fibres, or alternatively by integrated optical technology (in-waveguide device on a substrate).

The two outputs uₛ₁ and uₛ₂ of the optical splitter form a pair of branches R₁ and R₂ on each of which a filter FP1 or FP2 is located.

The outputs of the filters in both branches lead to an opto-electronic device 6, illustrated in detail in the following FIG. 4, and connected to a laser emission control unit 8.

This opto-electronic device 6 comprises, in particular, a pair of photodiodes PD₁ and PD₂, each receiving the optical signal from one of the two branches R₁ or R₂, a threshold comparator device 10 comprising a differential amplifier having its inputs connected to the outputs of the photodiodes. The outputs of the photodiodes are also added by means of an adder 12 which also preferably comprises a differential amplifier, and are sent to a counter 14 which can store the added signals from the photodiodes. Downstream of this counter 14 there is a digital-analogue converter DAC 16 which receives the digital signal emitted from the counter and which sends an analogue signal to the laser emission control unit 8.

The output U_{Δ} of the threshold comparator device 10 is also sent to the laser emission control unit 8.

The filters FP1 and FP2 are high-selectivity filters whose transfer function is shown in FIG. 5.

The applicant has discovered a method for making filters with this type of transfer function. In particular, these filters have a very narrow FSR, advantageously smaller by at least one order of magnitude (500 MHz−1 GHz) than the space between two adjacent channels of a dense multiple-wavelength (DWDM) signal. Additionally, their operating pass band is at least as wide as the band of a channel of a dense multiple-wavelength (DWDM) system as described above. This pass band determines the capture range CR of the locking structure.

In a preferred configuration, these filters FP1 and FP2 are Fabry-Perot interferometers with limited bandwidth, with bands adjacent to each other, which can be made, for example, by scribing two “chirped” gratings, with different “chirping” pitches from each other, placed in series in an optical fibre or in an optical waveguide.

The gratings are components formed by an alternation of areas having a high refractive index with areas having a low refractive index in the optical fibre or in the waveguide. The space between these areas is called the pitch of the grating. The pitch of the grating determines which wavelengths are reflected and which are transmitted. A “chirped” grating is a grating in which this pitch is variable, in other words the space between the areas with a high refractive index increases or decreases along the grating. In this type of grating, a signal at a given wavelength is reflected by a first area with a high refractive index, while a signal at a different wavelength is reflected by a second area, different from the first, which also has a high refractive index. The said variation of the pitch of the grating is called the chirping factor.

Patent application WO9636895 describes a method for scribing this type of grating in an optical fibre.

A Fabry-Perot interferometer is described, for example, in U.S. Pat. No. 4,400,058, and comprises an optical cavity delimited by a pair of substrates having a refractive index of less than 2.4, placed at a predetermined distance from each other.

A Fabry-Perot interferometer has a periodic optical transfer function according to the formula:

$$T = \frac{{( 1 - R )}^{2}}{1 + {R}^{2} - 2 R cos ( \frac{4 neff}{λ} Lc )} \qquad ( 1 )$$

where Lc is the length of the cavity, λ is the wavelength of the optical signal passing through this cavity, R is the reflectivity of the reflecting elements of the filter, and n_{eff} is the effective refractive index of the medium in which the optical beam is propagated in the filter.

In particular, this transfer function has peaks of transmissivity, spaced apart by a quantity which may be constant or variable, according to the type of technology used to produce the filter and the required functions, but which in any case depends on the value Lc of the optical cavity. In an optical fibre, this cavity can be made by scribing two areas with a high refractive index at a given distance from each other. The peaks of transmissivity become closer to each other as the distance between the positions of the two aforesaid areas increases.

FIG. 7 shows an example of the structure of the said filters made in an optical fibre. The first grating 21 has a chirping factor K₁, and the second grating 22 has a chirping factor K₂. The distance d between the first areas with a high refractive index of the two gratings, as shown in FIG. 7, produces a cavity of the Fabry-Perot type with a length d.

The pass band of this filter coincides, in this case, with the reflection bandwidth of the gratings, while the performance in terms of periodicity (FSR, i.e. free spectral range) and the widths of the periodic peaks are determined by the distance d between the gratings and by the relative chirping factors K₁ and K₂. These parameters characterize the Fabry-Perot effect which is created in the cavities delimited by them. The difference between the two chirping factors K₁ and K₂ defines a cavity which makes it possible to obtain peaks of transmissivity which are very close together (a very small FSR), together with a very small bandwidth BW (steepness of the peak), as described above and as illustrated in FIG. 8. This happens because this structure also shows a variation of the cavity length as a function of the wavelength. This is because a signal at a given wavelength is reflected at a different point from a signal at a different wavelength. Therefore, according to formula (1), dependence on the wavelength is present in two forms, one direct (the term λ in the formula) and one indirect (Lc, the cavity length, varies with the wavelength corresponding to the length d in FIG. 7).

A filter suitable for the characteristics of the ITU grid as defined above is a filter in which the difference between the two chirping facts is from 1 to 10 nm/cm and the distance d is in the range from 5 to 40 mm, for example one in which K₁ is 7 nm/cm and K₂ is 10 nm/cm, and the cavity length is approximately 20 mm. Additionally, for applications other than those relating to the aforesaid multiple-wavelength signals, these dimensions can be varied in order to obtain spectral steepnesses of the filters which differ from those indicated.

Additionally, if the length of the gratings is greater than the cavity length, the second grating is partially superimposed on the first grating, without modification of the characteristics of the resulting filter by the said superimposition

A filter with these characteristics can be used to produce a system of “latching” the wavelength, and therefore of locking it, with a digital circuit as described above. The two filters are centred on two wavelengths which differ slightly from each other, one being greater and one being smaller than the operating wavelength to be locked, so that adjacent bandwidths are obtained for the two structures (see FIG. 5).

The wavelength locking device operates in the following way:

A predetermined portion of the optical signal at the wavelength λ emitted by the laser 411 is extracted by the coupler 2 and sent from the output uₛ to the splitter 4, which divides this signal portion into two branches R1 and R2. The filters FP1 and FP2 have transfer functions which are shown superimposed in FIG. 5. In particular, the filter FP1 has the spectrum shown in FIG. 5 when λ≦λₗₜᵤ, and a uniform transmissivity approximately equal to that corresponding to λ=λₗₜᵤ when λ>λₗₜᵤ. The filter FP2 has the spectrum shown in FIG. 5 when λ≧λᵢₜᵤ, and a uniform transmissivity approximately equal to that corresponding to λ=λₗₜᵤ when λ<λᵢₜᵤ.

At the outputs of the said filters, the optical signal is maximized, within the pass band of the filter, when its wavelength is at one of the peaks P, whereas it is attenuated in all other areas. The peaks are equally spaced from each other according to a predetermined FSR during the construction of the filters. FIG. 5 shows that the transfer functions of the two filters are symmetrical with respect to each other, and the axis of symmetry is represented by the nominal wavelength to be locked, λₗₜᵤ. Thus one filter detects the displacements to values below the nominal value of this wavelength, while the other detects the displacements to values above the nominal value of this wavelength.

The signal emitted by the photodiode PD1 is therefore a signal corresponding to a displacement of the wavelength λ to be locked to values below the nominal value λₗₜᵤ, and the signal emitted by the photodiode PD2 is a signal corresponding to a displacement of the wavelength λ to be locked to values above the nominal value λₗₜᵤ. Both of the signals generated by the photodiodes PD1 and PD2 are presented as a set of electrical impulses, since FP1 and FP2 transmit light to the photodiodes only when the optical signal at their inputs has a wavelength λ corresponding to the wavelength of the signal to be locked, or to a wavelength which is a multiple of the said pitch (FSR).

The number of the electrical impulses emitted by the photodiodes PD1 and PD2 can be used to determine the amount by which the wavelength of the signal to be locked has been displaced from its nominal value. This is because, if the number of impulses emitted by PD1 is n₁, the wavelength λ of the signal to be locked is equal to λₗₜᵤ−n₁*FSR. If the number of impulses emitted by PD2 is n₂, the wavelength λ of the signal to be locked is equal to λₗₜᵤ−n₂*FSR. It should be noted that the signal is emitted only by either the photodiode PD1 or the photodiode PD2, since the transfer function of the two filters allows the optical beam to proceed only in one of the two branches, depending on whether the wavelength is smaller than the nominal value λᵢₜᵤ (branch R1) or greater than the nominal value λᵢₜᵤ (branch R2). The signals emitted by the photodiodes are sent to the threshold comparator 10, which determines whether the signal received from one of the two photodiodes signifies a displacement of the wavelength of the signal to be locked. This is because, when the wavelength of the optical signal to be locked is displaced from the nominal wavelength λᵢₜᵤ, both filters transmit to the photodiodes a signal having an optical power lower than that transmitted at the nominal wavelength λₗₜᵤ. Consequently, the electrical signal emitted by the said photodiodes decreases, and the threshold comparator 10 detects this decrease and changes the state of its output.

The pair of signals at the output from the threshold comparator 10 and the counter 14 exactly describe the variation of the wavelength of the optical signal to be locked. The signal emitted from the counter 14 is a digital signal; the digital-analogue converter 16 supplies a corresponding analogue signal to the laser emission control unit 8, as shown in the graph in FIG. 6. By constantly monitoring the said two signals, the control unit is able to act on the emission of the source in such a way as to correct the displacement of the wavelength which occurs.

An example of the mode of operation is shown in the following table.

| | | | | Com- | | |
|---|---|---|---|---|---|---|
| | | | | para- | Count- | |
| seq | λ | PD1 | PD2 | tor | er | notes |
| 1 | λ = λᵢₜᵤ | V₁ = high | V₂ = hiqh | Ind. | 0 | Feedback |
| | | | | | | inactive |
| 2 | λ > λᵢₜᵤ | V₁ = high | V₂ = high | Ind. | 0 | The wave- |
| | | | | | | band of |
| | | | | | | FP2 has not |
| | | | | | | yet been |
| | | | | | | reached |
| 3 | λ >> λᵢₜᵤ | V₁ = high | V₂ < V₁ | + | 0 | Trailing edge |
| | | | | | | along the |
| | | | | | | waveband of |
| | | | | | | FP2 |
| 4 | λ >>> λᵢₜᵤ | V₁ = high | V₂ = low | + | 0 | Before the |
| | | | | | | first peak |
| 5 | λ >>>> λᵢₜᵤ | V₁ = high | V₂ < V₁ | + | 1 | Leading |
| | | | | | | edge of the |
| | | | | | | first peak |
| | | | | | | (the feed- |
| | | | | | | back ends¹) |

The steps which the wavelength locking device carries out when the wavelength λ varies are numbered progressively in the table. By way of example, a displacement of the wavelength λ towards wavelengths greater than the nominal wavelength λₗₜᵤ of emission of the source is assumed.

In step 1, the locking device does not detect any anomaly, because the wavelength λ has not undergone any displacement.

In step 2, the wavelength λ is displaced towards higher values, but the locking device still does not detect any anomaly, since the amount of displacement is not yet detectable by the filter FP2 and therefore the comparator does not detect any non-uniformity in the two signals from the photodiodes PD1 and PD2.

In step 3, the comparator detects a difference between the two signals from the photodiodes and recognizes the direction “+” of this displacement.

In step 4, the comparator continues to detect this difference between the two signals from the photodiodes, and confirms the direction “+” of this displacement.

In step 5 the counter has received the first impulse, counts 1 and sends this digital signal to the digital-analogue converter.

From this instant, the system is subject to feedback and is controlled; a pair of control signals (+, 1) is applied to the source emission control unit 8. This unit has been configured in such a way as to respond in a proportional way to the input control signal, according to a constant directly proportional to the FSR of the filters FP1 and FP2.

If there is a progressive decrease of the emission wavelength below the nominal emission wavelength λᵢₜᵤ, the operation of the locking device is a mirror image of the preceding case. When the first peak of the, spectral response of the filter FP1 is reached, a pair of control signals (−; 1) is sent to the control unit. If there is a rapid variation of the emission wavelength, the counter counts the number of peaks of the spectrum of FP1 or FP2 passed through, and a corresponding control signal (±; n), where the sign + or − corresponds to the direction of the variation of the wavelength, is sent to the control unit.

1. Method for locking the wavelength of an optical signal emitted by a source, comprising the following stages:
extracting a fraction of the said optical signal emitted by the said source;
filtering the said fraction of the said optical signal in such a way as to generate a first optical signal when corresponding to its wavelength is displacementd towards values below the nominal wavelength, a second optical signal corresponding towhen its wavelength is displacementd towards values above the nominal wavelength,
converting the said first optical signal and the said second optical signal into an electrical signal,
generating a signal identifying the direction of the said displacement,
characterized in generating a further signal corresponding to the size of the said displacement and a signal identifying the direction of the said displacement, both signalsof which are to be used for adjusting the emission spectrum of the said source.

2. Method according to claim 1, in which the said stage of filtering the said fraction of the said optical signal comprises:
dividing the said fraction of the said optical signal into a first sub-fraction and a second sub-fraction,
filtering the said first sub-fraction in such a way as to generate a first optical signal corresponding towhen its wavelength is diplacementd towards values below the nominal wavelength,
filtering the said second sub-fraction in such a way as to generate a second optical signal corresponding to when its wavelength is displacementd towards values above the nominal wavelength.

3. Method according to claim 1, in which the said stage of generating a signal proportional to the size of the said displacement comprises counting the pulses of the said electrical signal.

4. Device for locking the wavelength of an optical signal emitted by a source, comprising:
a coupler (2) capable of extracting a fraction of the said optical signal,
a splitter (4) capable of dividing the said fraction of the said optical signal into a first sub-fraction and a second sub-fraction, characterized in that it comprises:
a first filter (FP1) capable of filtering the said first sub-fraction and of generating an optical signal corresponding towhen its wavelength is displacementd to values below the wavelength of the optical signal to be locked,
a second filter (FP2) capable of filtering the said second sub-fraction and of generating an optical signal corresponding towhen its wavelength is displacementd to values above the wavelength of the optical signal to be locked,
an opto-electronic device (6) capable of converting the said first filtered sub-fraction of the optical signal and the said second filtered sub-fraction of the optical signal, and of generating a signal corresponding to the said size of the displacement and a signal identifying the direction of the said displacement,
an emission control unit (8), characterized in that said opto-electronic device (6) is also capable of generating a further signal corresponding to the size of the displacement, both signals of which are adapted to be used by the control unit (8) to adjust the emission spectrum of the said source.

5. Device according to claim 4, in which the said opto-electronic device (6) comprises:
a pair of photodiodes (PD1, PD2),
a threshold comparator device (10), comprising a differential amplifier, to whose inputs the signal emitted by the said pair of photodiodes is applied,
an adder (12), comprising a differential amplifier to whose inputs the signal emitted by the said pair of photodiodes is applied,
a counter (14) which receives the signal from the output of the said adder,
a digital-analogue converter (16) which receives the signal from the output of the said adder.

6. Device (FP1; FP2) for filtering an optical signal, comprising:.
a first grating (21) having a first chirping factor (k₁),
a second grating (22) having a second chirping factor (k₂),
characterized in that the said first grating (21) and the said second grating (22) beingare arranged in series with a predetermined distance (d) between them, to form a Fabry-Perot cavity having a length equal to the said predetermined distance (d), characterized in that.

7. Device according to claim 7, in which the said first chirping factor (k₁) is different from the said second chirping factor (k₂).

78. Device according to claim 67, in which the said first grating (21) and second grating (22) are formed in an optical fibre.

89. Device according to claim 67, in which the said first grating (21) and second grating (22) are formed in an optical waveguide.

9. Device according to any of claims 6 to 8, having a FSR comprised between 500 MHz and 1 GHz.

10. Device according to any of claims 6 to 9, in which the difference between the first (k₁) and the second (k₂) chirping factor is comprised between 1 and 10 nm/cm.

11. Device according to any of claims 6 to 10, in which said predetermined distance (d) is comprised between 5 and 40 mm.
